(19) United States
(12) Patent Application Publication
(10) Pub. No.: US 2016/0267590 A1
(43) Pub. Date: Sep. 15, 2016

(54) METHODS AND SYSTEMS OF PERFORMING RISK MANAGEMENT OF TRANSACTIONS

(71) Applicant: Matrix Trading Technologies, LLC, New York, NY (US)

(72) Inventor: Louis Feng Liu, New York, NY (US)

(21) Appl. No.: 14/645,891

(22) Filed: Mar. 12, 2015

(51) Int. Cl. G06Q 40/04

(52) U.S. Cl. CPC G06Q 40/04

(57) ABSTRACT

A risk management system may include a client-side optical device, a market-side optical device associated with a marketplace exchange, and a risk processing device in communication with the client-side optical device and the market-side optical device. The risk processing device may include a first media access controller, a second media access controller, and a risk processing unit in communication with the first media access controller and the second media access controller. The client-side optical device may be configured to receive a securities order from a client electronic device, generate a copy of the received securities order, route the securities order to the market-side optical device, and route the copy to the risk processing device. The risk processing device may be configured to determine whether the securities order violates one or more rules, and in response to determining that the securities order violates one or more rules, perform remedial actions.

### BACKGROUND

The United States' Securities and Exchange Commission's Regulation 15c3-5 was implemented to obligate broker/dealers to establish and maintain a system of risk management controls to control risks associated with market access. These controls include, among others, procedures that limit financial exposure, prevent entry of orders exceeding capital thresholds, and prevent entry of erroneous orders.

Current risk management systems utilize software to determine security order compliance. However, the use of such systems imposes latency into the order placement process, which is undesirable in the securities trading industry.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a risk management system may include a client-side optical device, a market-side optical device associated with a marketplace exchange, and a risk processing device in communication with the client-side optical device and the market-side optical device. The risk processing device may include a first media access controller, a second media access controller, and a risk processing unit in communication with the first media access controller and the second media access controller. The client-side optical device may be configured to receive a securities order from a client electronic device, generate a copy of the received securities order, route the securities order to the market-side optical device, and route the copy to the risk processing device. The risk processing device may be configured to determine whether the securities order violates one or more rules, and in response to determining that the securities order violates one or more rules, perform one or more remedial actions.

In an embodiment, a method of managing risk associated with securities orders may include receiving, by a client-side optical device, a securities order, generating, by the client-side optical device, a copy of the securities order, routing the securities order to a market-side optical device associated with a marketplace exchange, routing the copy to a risk processing device, determining, by the risk processing device, whether the securities order violates one or more rules, and in response to determining that the securities order violates one or more rules, performing one or more remedial actions.

In an embodiment, a method of managing risk associated with securities orders may include receiving, by a market-side optical device associated with a marketplace exchange, order information pertaining to one or more securities orders, generating, by the market-side optical device, a copy of the order information, routing the order information to a client-side electronic device, routing the copy to a risk processing device, determining, by the risk processing device, whether the order information violates one or more rules, and in response to determining that the order information violates one or more rules, performing one or more remedial actions.

### BRIEF DESCRIPTION OF THE DRAWINGS

FIG. 1A illustrates an example securities trading risk management system according to an embodiment.

FIG. 1B illustrates an example control and management system according to an embodiment.

FIG. 2 illustrates an example risk management system according to an embodiment.

FIG. 3 illustrates a flow chart of an example client-to-market method of managing risk of securities orders according to an embodiment.

FIG. 4 illustrates a flow chart of an example market-to-client method of managing risk of securities orders according to an embodiment.

FIG. 5 depicts a block diagram of hardware that may be used to contain or implement program instructions.

### DETAILED DESCRIPTION

The following terms shall have, for purposes of this application, the respective meanings set forth below:

A “computing device” or “electronic device” refers to a device that includes a processor and non-transitory, computer-readable memory. The memory may contain programming instructions that, when executed by the processor, cause the computing device to perform one or more operations according to the programming instructions. As used in this description, a “computing device” or “electronic device” may be a single device, or any number of devices having one or more processors that communicate with each other and share data and/or instructions. Examples of computing devices or electronic devices include personal computers, servers, mainframes, gaming systems, televisions, and portable electronic devices such as smartphones, personal digital assistants, cameras, tablet computers, laptop computers, media players and the like.

A “marketplace exchange” refers to an electronic forum where securities, futures, option contracts, foreign exchanges, commodities and/or the like may be bought and sold.

A “securities order” refers to one or more electronic instructions to buy or sell securities. A securities order may include one or more data packets or transaction packets pertaining to a securities trade.

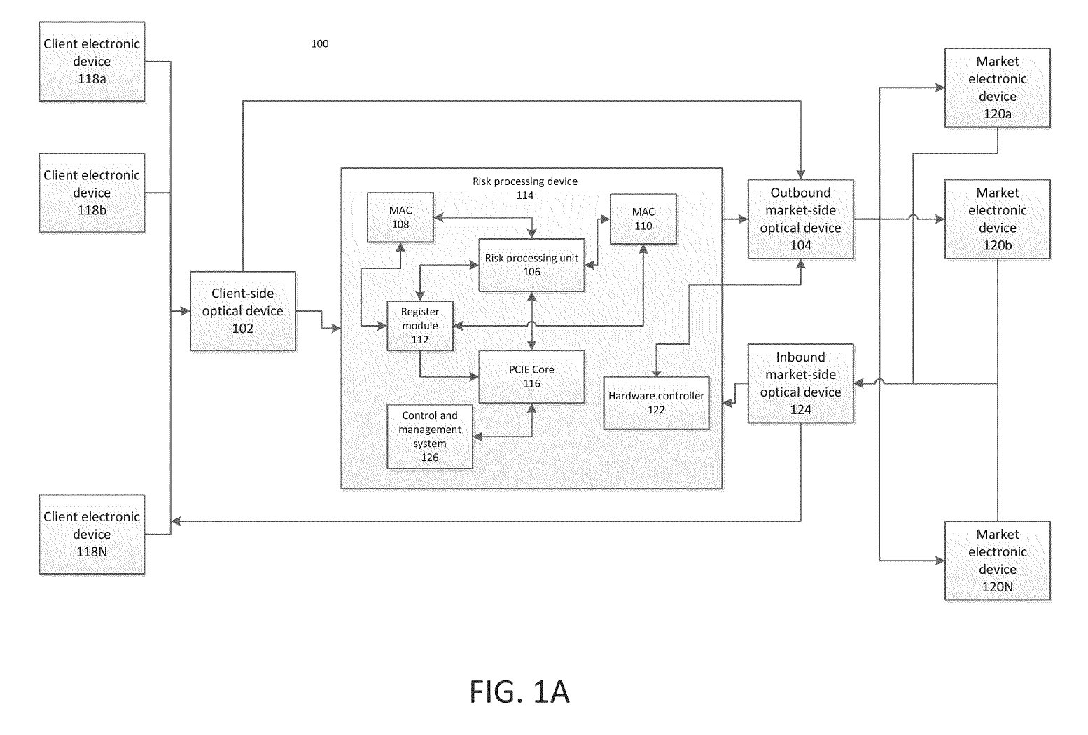

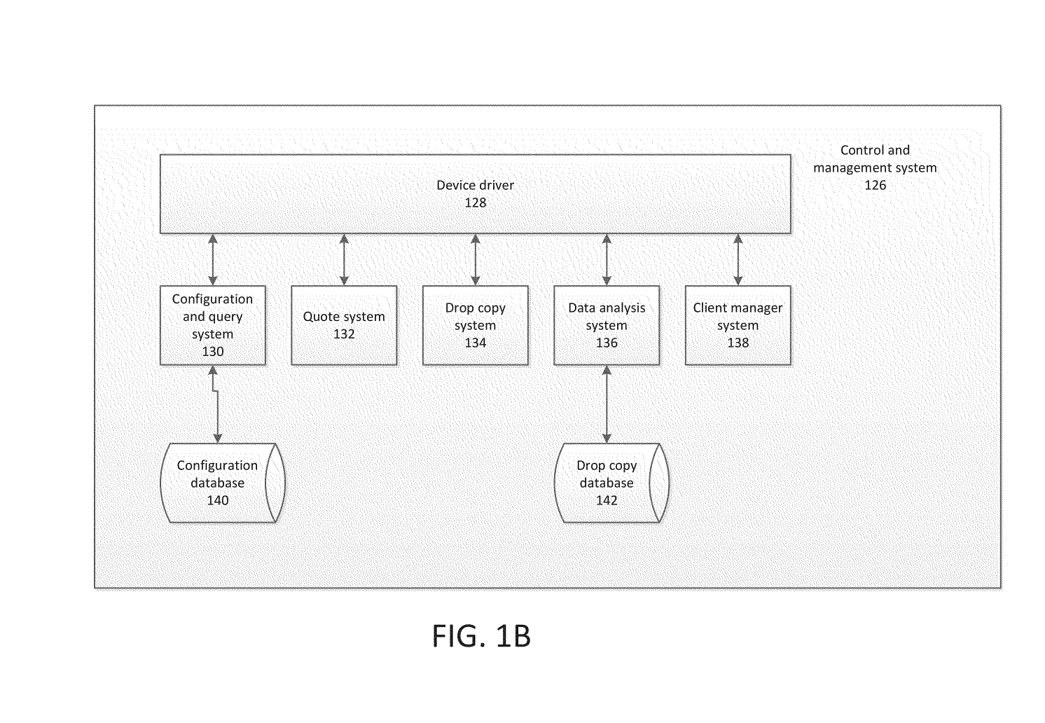

FIG. 1A illustrates an example securities trading risk management system according to an embodiment. As illustrated by FIG. 1A, a risk management system 100 may include a client-side optical device 102, an outbound market-side optical device 104, an inbound market-side optical device 124 and a risk processing device 114.

In an embodiment, an outbound market-side optical device 104 may be configured to facilitate the transmission of information, such as, for example, a securities order from a client electronic device 118a-N to a market electronic device 120a-N. Similarly, an inbound market-side optical device 124 may be configured to facilitate the transmission of information, such as, for example, order information, from a market electronic device 120a-N to a client electronic device 118a-N. In some embodiments, the inbound market-side optical device 124 may be in communication with the risk processing device 114.

In various embodiments, one or more of the optical devices 102, 104, 124 may be an optical switch, an optical splitter and/or the like. For instance, in an embodiment, a client-side optical device 102 may be an optical splitter, an outbound market-side optical device 104 may be an optical switch, and an inbound market-side optical device 124 may be an optical splitter. Additional and/or alternate configurations may be used within the scope of this disclosure.

In an embodiment, an outbound market-side optical device 104 and an inbound market-side optical device 124 may be embodied in a single optical device. For instance, a single optical switch may embody the outbound market-side optical device 104 and an inbound market-side optical device 124.

The risk processing device 114 may include at least two media access controllers (MAC) 108, 110. In certain embodiments, one or more of the MACs 108, 110 may be 10 Gigabits per second MACs, although additional and/or alternate MACs may be used within the scope of this disclosure. The risk processing device 114 may also include a register module 112, a risk processing unit 106 and a PCI Express (PCIe) core 116.

In certain embodiments, a risk processing device 114 may include one or more hardware controllers 122. One or more of the hardware controllers 122 may be in communication with the client-side optical device 102 and/or the outbound market-side optical device 104.

As illustrated by FIG. 1A, the risk management system 100 may be in communication with one or more client electronic devices 118a-N and one or more marketplace exchange electronic devices 120a-N. A client electronic device 118a-N may be used by a user, such as a broker/dealer, to place one or more securities orders. In an embodiment, a marketplace exchange electronic device 120a-N may be an electronic device associated with one or more marketplace exchanges, such as securities markets. A marketplace exchange electronic device 120a-N may receive a securities order and may effect the transaction(s) contemplated by the order.

FIG. 1B illustrates that a risk processing device 114 may include a control and management system 126. In an embodiment, a control and management 126 system may interface with a PCIe core of a risk processing device 114. In certain embodiments, one or more other communication methods such as, for example, User Datagram Protocol (UDP) and Transmission Control Protocol/Internet Protocol (TCP/IP), may be used. A control and management system 126 may be implemented in hardware, software or a combination of hardware and software. A control and management system may store information pertaining to one or more transactions.

In certain embodiments, the risk processing device 114 may include one or more hardware components such as, for example, one or more field gate programmable array (FPGA) chips. For example, one or more of the MACs 108, 110, the register module 112, the risk processing unit 106, the PCIe core 116 and the hardware controller 122 may be implemented using one or more FPGA chips.

The control and management system 126 may serve as an interface through which the hardware of the risk processing device 114 may be controlled, managed, monitored and/or the like. For example, the control and management system 126 may allow users and/or a control manager to control, manage and/or monitor the risk processing device's hardware such as, for example, one or more FPGA chips.

As illustrated by FIG. 1B, a control and management system 126 may include a device driver 128, a configuration and query system 130, a quote system 132, a drop copy system 134, a data analysis system 136 and a client manager system 138. These systems 130, 132, 134, 136, 138 may perform one or more actions pertaining to a securities order and/or order information. For example, a configuration and query system 130 may be in communication with a configuration database 140, and may add, modify and/or delete one or more risk rules. As another example, a drop copy system 134 may be in communication with a drop copy database 142. The drop copy system 134 may receive drop copies from a risk processing device, and these drop copies may be stored in the drop copy database 142, local storage such as, for example, a hard drive, solid state drive and/or the like, and/or network storage such as, for example, a storage area network, network attached storage, and/or the like. One or more drop copies may be sent to one or more other devices via a network connection according to an embodiment.

The client management system 138 may be in communication with a control manager (as described in more detail below), and may send information pertaining to the risk processing device to and receive such information from the control manager. This information may include, without limitation, information about one or more rules utilized by the risk processing device, one or more configurations or settings associated with the risk processing device, and one or more statistics associated with the risk processing device or the use of the risk processing device. Additional and/or alternate systems may be used within the scope of this disclosure.

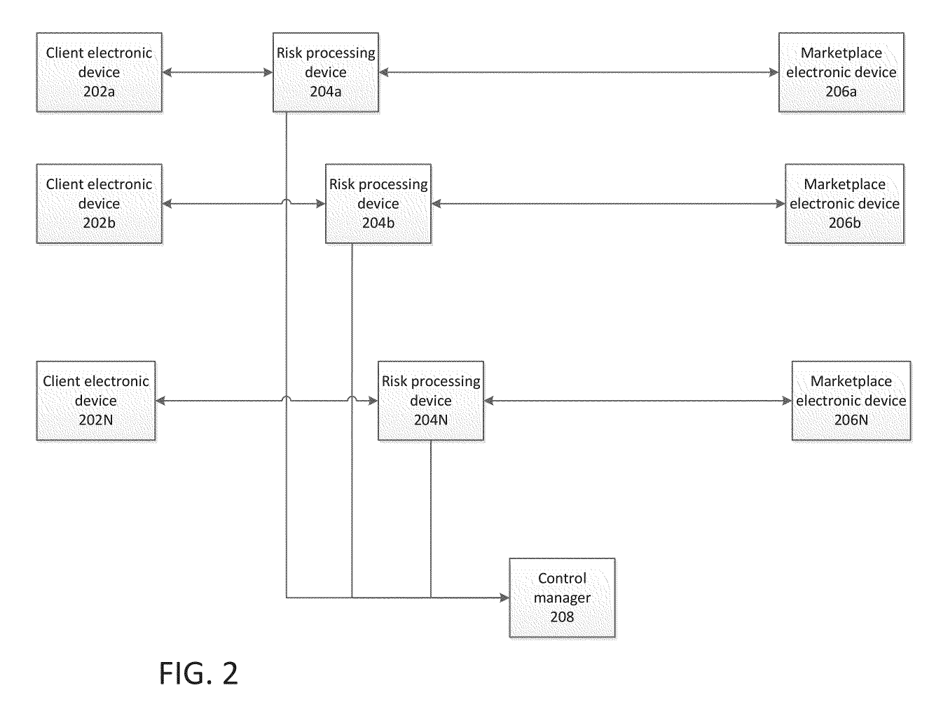

FIG. 2 illustrates an example risk management system according to an embodiment. As illustrated by FIG. 2, a risk management system 200 may include one or more client electronic devices 202a-N, one or more risk processing devices 204a-N, one or more marketplace exchange electronic devices 206a-N, and a control manager 208. Each risk processing device 204a-N may be in communication with one or more of the client electronic devices 202a-N, one or more of the marketplace exchange electronic devices 206a-N and the control manager 208. The control manager 208 may receive information from and/or send information to one or more risk processing devices 204a-N. For instance, a control manager 208 may interface with the client management system 138 of one or more risk processing devices. A control manager may be implemented as an electronic device. In an embodiment, the control manager may aggregate certain information, statistics, usage information and/or the like across one or more risk processing devices. The control manager may present this information to a user via a GUI, an API and/or the like.

For instance, the control manger may collect information from one or more risk processing devices pertaining to the rules that were violated over a certain period of time. This information may include, for one or more risk processing devices, an indication of the rule or rules that were violated, a number of times the rule was violated and/or the like. The control manager may collect this information and may present aggregate information to a user. For instance, the control manager may notify a user of the total number of times that a rule was violated over a period of time by all corresponding risk processing devices. Additional and/or alternate information may be received, collected and/or presented within the scope of this disclosure.

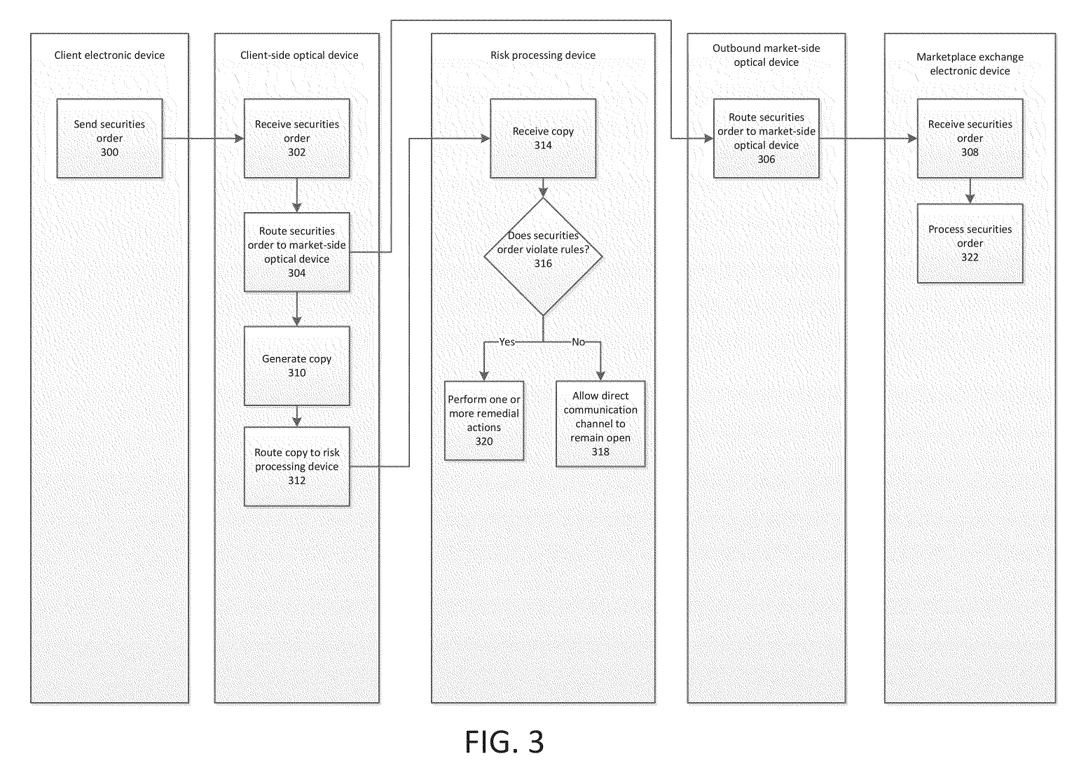

FIG. 3 illustrates a flow chart of an example client-to-market method of managing risk of securities orders according to an embodiment. As illustrated by FIG. 3, a securities order may be sent 300 by a client electronic device, and may be received 302 by a client-side optical device. In an embodiment, the client-side optical device may route 304 the securities order directly to the outbound market-side optical device and the outbound market-side optical device may receive 306 the securities order. The outbound market-side optical device may route 308 the order to one or more market electronic devices. The one or more electronic devices may receive the securities order, and may process 322 the securities order to effect the transaction(s) contemplated by the order. Because this path bypasses the risk management device, the order may be processed with very little latency.

In an embodiment, the client-side optical device may generate 310 a copy of the received securities order. The client-side optical device may route 312 the copy to a risk processing device. A risk processing device may receive 314 the copy and may determine 316 whether the securities order violates one or more rules. For example, a MAC of a risk processing device may receive the copy from the client-side optical device, and may route the copy to a risk processing unit. The risk processing unit may receive the copy, and may determine 316 whether the securities order violates one or more rules. In an embodiment, a risk processing unit may determine 316 whether a securities order violates one or more rules by performing one or more risk checks on the order. A risk check may involve the comparison of one or more characteristics of an order with one or more rules. In an embodiment, a rule may be specified by SEC Regulation 15c3-5 or another law or regulation. In another embodiment, a rule may be specified by a system administrator or operator.

For example, under SEC Regulation 15c3-5, clearly erroneous orders should not be forwarded to a marketplace exchange. A clearly erroneous order may be one that includes an obvious error as to price, number of shares or other trading unit, identification of the security and/or the like. For example, an order that identifies a security to buy by a symbol that does not exist may be deemed to be an erroneous order.

As another example, a rule may exist that duplicative orders should not be forwarded to a marketplace exchange. A duplicative order may be one that matches the price, number of shares or other trading unity, security and/or other characteristics of a different order previously received within a certain time period. For instance, an order for 500 shares of Security 1 at $24.45 per share may be received. If another order for 500 shares of Security 1 at $24.45 per share is received within two seconds of the first order, it may be deemed to be a duplicative order and may not be forwarded to a marketplace exchange. Additional and/or alternate characteristics and/or time periods may be used in determining whether an order is a duplicate according to this disclosure.

As another example, a rule may exist that tracks buying power. The risk processing unit may have an initial buying power credit that may be pre-configured. The risk processing unit may track buying power credit consumption of one or more orders that it receives. For example, a new order may consume buying power credit by an amount equal to price/share * number of shares * discount. If the buying power credit of an order is less than a remaining buying power credit, the remaining buying power credit may be reduced by the buying power credit of the order. If an order will consume more buying power than the current remaining buying power, it may be deemed a violation of a buying power rule.

As another example, a rule may exist that a trader must maintain a minimum equity value. If an account falls below the requirement, trading may be suspended until the account balance is restored to the minimum requirement.

In certain embodiments, one or more rules may be programmed into at least a portion of the hardware of the risk processing device. For instance, one or more rules may be programmed into an FPGA chip of the risk processing device. As another example, a table of trading symbols may be programmed into at least a portion of the hardware of the risk processing device. The table may be updated and/or modified, and may include any number of trading symbols.

In an embodiment, if the risk processing unit determines 316 that a securities order does not violate one or more rules, the risk processing device may allow 318 the direct communication channel between the client-side optical device and the outbound market-side optical device to remain open. For example, the risk processing unit may instruct one or more hardware controllers to cause the client-side optical device and/or the outbound market-side optical device to select the direct communication channel between the client-side optical device and the outbound market-side optical device.

In an embodiment, if the risk processing unit determines 316 that a securities order violates one or more rules, the risk processing unit may perform 320 one or more remedial actions. A remedial action may be an action taken to address and/or mitigate an impact of a securities order that violates one or more rules.

In an embodiment, a remedial action may involve invalidating the securities order. The risk processing unit may invalidate the securities order by changing one or more values associated with the securities order. For instance, the risk processing unit may change the value of a “number of shares” field to be “0.” As another example, the risk processing unit may change the value of the “symbol” field of an order to reflect an invalid, non-existent or test symbol. In an embodiment, the risk processing unit may convert a packet that includes the securities order into a known erroneous packet on the network level. The risk processing unit may route the invalidated securities order to the outbound market-side optical device. Because the securities order has been invalidated, however, the applicable marketplace exchange may reject the securities order.

In various embodiments, a remedial action may involve the risk processing unit preventing one or more subsequent securities orders from being sent to a market exchange. For instance, the risk processing unit may prevent one or more subsequent securities orders placed by the same trader that placed a securities order that violates one or more rules from being placed. As another example, the risk processing unit may prevent one or more subsequent securities orders received from the same client electronic device from which a securities order that violates one or more rules was received.

Another remedial action may involve the risk processing unit notifying a user that the securities order violates one or more rules. This notification may be in the form of a graphical user interface message or notification, application program interface (API), an email message, a short message service (SMS) message and/or the like.

In an embodiment, a remedial action may involve the risk processing unit causing the direct communication channel from the client-side optical device to the outbound market-side optical device to be disconnected. For example, the risk processing unit may instruct one or more hardware controllers to cause the client-side optical device and/or the outbound market-side optical device to select the communication channel that goes through the risk processing device, thereby disconnecting the direct communication channel and preventing the client-side optical device from sending information directly to the outbound market-side optical device. For example, referring back to FIG. 1A, a securities order may progress from a client electronic device 118a-N to a client-side optical device 102, to a MAC 108, to a risk processing device unit 106, to a MAC 110, to an outbound market-side optical device 104 to a market electronic device 120a-N. In other embodiments, the risk processing unit may cause a connection from a client electronic device to a marketplace exchange electronic device to be completely severed.

In certain embodiments, the risk processing device may cause the direct communication channel to be reestablished after a certain period of time, after a certain number of securities orders that do not violate one or more rules are processed, after receiving instructions from a user and/or the like. For instance, the risk processing unit may instruct one or more hardware controllers to cause a client-side optical device and/or an outbound market-side optical device to select a direct communication channel between the client-side optical device and the outbound market-side optical device after a certain period of time has passed, after a certain number of securities orders that do not violate one or more rules are processed, after receiving instructions from a user and/or the like.

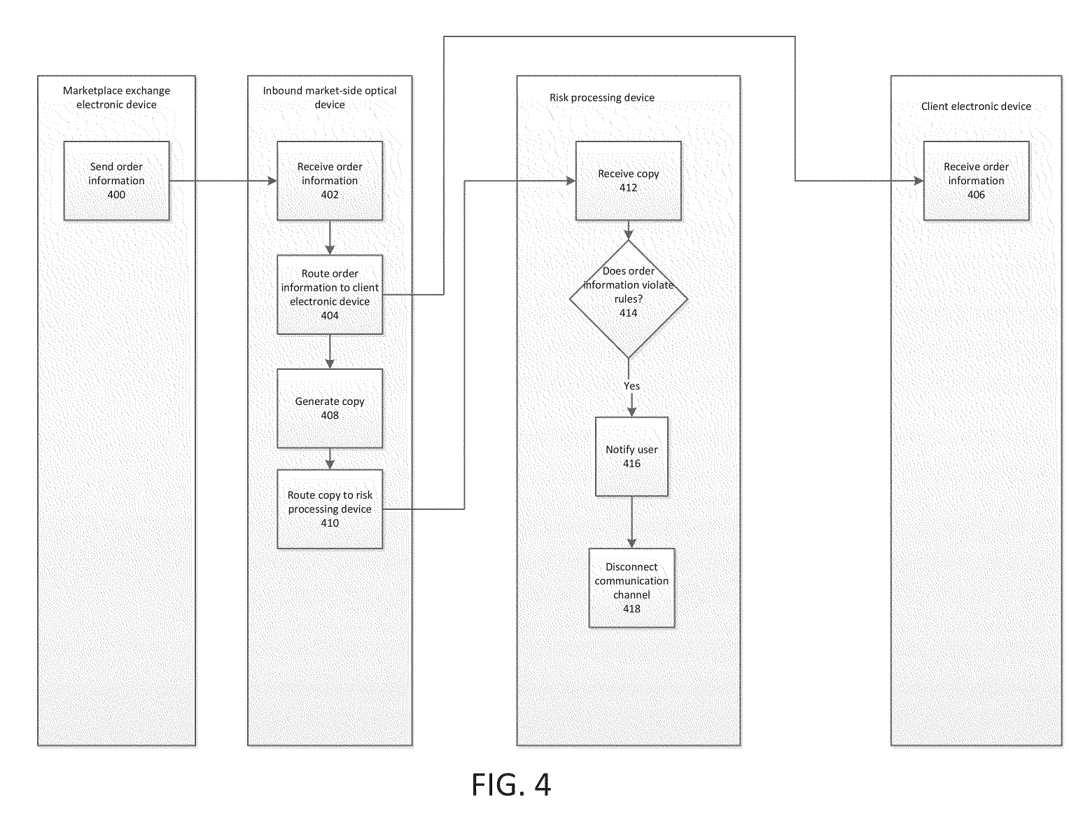

FIG. 4 illustrates a flow chart of an example market-to-client method of managing risk of securities orders according to an embodiment. As illustrated by FIG. 4, order information may be sent 400 by a marketplace exchange electronic device, and may be received 402 by an inbound market-side optical device. Order information may include electronic data pertaining to one or more securities orders. In an embodiment, order information may include electronic data pertaining to one or more securities orders that were placed by one or more client electronic devices such as, for example, order acknowledgments, execution reports, cancellation reports, messages and/or the like.

In an embodiment, the inbound market-side optical device may route 404 the order information directly to a client electronic device. In an embodiment, the inbound market-side optical device may route 404 the order information to one or more client electronic devices that placed the corresponding securities order and the one or more client electronic devices may receive 406 the order information. Because this path bypasses the risk management device, the order information may be transmitted with very little latency.

In an embodiment, the inbound market-side optical device may generate 408 a copy of the received order information. The inbound market-side optical device may route 410 the copy to a risk processing device. A risk processing device may receive 412 the copy from the inbound market-side optical device, and may determine 414 whether the order information violates one or more rules. For example, a MAC of a risk processing device may receive 412 the copy and may route the copy to a risk processing unit. The risk processing unit may determine 414 whether the order information violates one or more rules. In an embodiment, a risk processing unit may determine 414 whether order information violates one or more rules by performing one or more risk checks on the information. A risk check may involve the comparison of one or more characteristics of order information with one or more rules. In an embodiment, a rule may be specified by SEC Regulation 15c3-5 or another law or regulation. In another embodiment, a rule may be specified by a system administrator or operator. Rules, such as those discussed in more detail above, may be used in various embodiments.

In certain embodiments, one or more rules may be programmed into at least a portion of the hardware of the risk processing device. For instance, one or more rules may be programmed into an FPGA chip of the risk processing device.

In an embodiment, if the risk processing unit determines 414 that the order information violates one or more rules, the system may notify 416 a user that the order information violates one or more rules. This notification may be in the form of a graphical user interface message or notification, API, an email message, a short message service (SMS) message and/or the like. The risk processing unit may prevent further securities orders from being sent to the marketplace until this violation is resolved, instructions are received from a user and/or the like.

In an embodiment, the risk processing unit may also disconnect 418 the direct communication channel from the inbound market-side optical device to one or more client electronic devices. For example, one or more hardware controllers of a risk processing device may prevent the inbound market-side optical device from sending information to a client electronic device. In certain embodiments, the direct communication channel may be reestablished after a certain period of time, after a certain number of securities orders that do not violate one or more rules are processed, after receiving instructions from a user and/or the like.

In certain embodiments, the system may generate one or more drop copies of securities orders and/or order information. A drop copy may be a copy of a securities order or order information. In some embodiments, a drop copy may be a near real-time copy of a securities order and/or order information. The system may generate one or more drop copies of a securities order when it is received from a client electronic device and/or when it is sent from the system to a marketplace exchange electronic device. In an embodiment, the system may generate one or more drop copies of order information when it is received from a marketplace exchange electronic device and/or when it is sent from the system to a client electronic device. In certain embodiments, one or more MACs of a risk management system may generate one or more drop copies, and may send the drop copies to a PCIe core, or via another communication method such as, for example, UDP or TCP/IP. The PCIe core may send the drop copies to one or more storage media or devices. In an embodiment, one or more drop copies may be sent to one or more other electronic devices via a network connection.

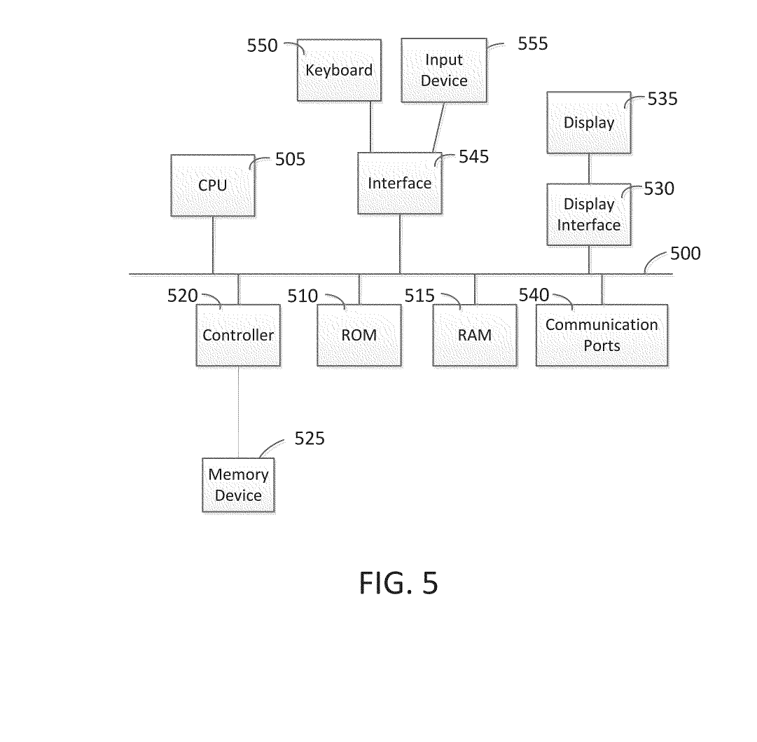

FIG. 5 depicts a block diagram of hardware for one or more electronic devices, such as, for example, client electronic devices or market electronic devices, that may be used to contain or implement program instructions. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an example of a production device, computing device or processor as such terms are used within this disclosure. Read only memory (ROM) 510 and random access memory (RAM) 515 constitute examples of non-transitory computer-readable storage media.

A controller 520 interfaces with one or more optional non-transitory computer-readable storage media 525 to the system bus 500. These storage media 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible, non-transitory computer-readable medium such as a compact disk, a digital disk, flash memory, a memory card, a USB drive, an optical disc storage medium and/or other recording medium.

An optional display interface 530 may permit information from the bus 500 to be displayed on the display 535 in audio, visual, graphic or alphanumeric format. Communication with external devices, such as a printing device, may occur using various communication ports 540. A communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A risk management system comprising:
a client-side optical device;
a market-side optical device associated with a marketplace exchange; and
a risk processing device in communication with the client-side optical device and the market-side optical device, wherein the risk processing device comprises:
a first media access controller,
a second media access controller, and
a risk processing unit in communication with the first media access controller and the second media access controller,
wherein the client-side optical device is configured to:
receive a securities order from a client electronic device,
generate a copy of the received securities order,
route the securities order to the market-side optical device, and
route the copy to the risk processing device,
wherein the risk processing device is configured to:
determine whether the securities order violates one or more rules, and
in response to determining that the securities order violates one or more rules, perform one or more remedial actions.

2. The system of claim 1, wherein the risk processing unit comprises one or more field-programmable gate array chips.

3. The system of claim 1, wherein the client-side optical device is in communication with one or more client electronic devices, and the market-side optical device is in communication with one or more marketplace exchange electronic devices.

4. The system of claim 1, wherein the one or more remedial actions comprise:
invalidating the securities order; and
routing the invalidated securities order to the market-side optical device.

5. The system of claim 1, wherein the one or more remedial actions comprise causing a communication channel from the client-side optical device and the market-side optical device to be disconnected.

6. The system of claim 1, wherein the one or more remedial actions comprise not routing one or more subsequently received securities orders to the market-side optical device.

7. The system of claim 1, wherein the one or more remedial actions comprise notifying a user that the securities order violates the one or more rules.

8. The system of claim 1, further comprising a second market-side optical device in communication with the risk processing unit.

9. The system of claim 8, wherein:
the second market-side optical device is configured to:
receive order information from a marketplace exchange electronic device,
generate a copy of the order information,
route the order information to the client electronic device, and
route the copy to the risk processing device,
wherein the risk processing device is further configured to determine whether the order information violates one or more rules.

10. The system of claim 1, wherein the risk processing device is further configured to access one or more rules that are stored by the risk processing device.

11. A method of managing risk associated with securities orders, the method comprising:
receiving, by a client-side optical device, a securities order;
generating, by the client-side optical device, a copy of the securities order;
routing the securities order to a market-side optical device associated with a marketplace exchange;
routing the copy to a risk processing device;
determining, by the risk processing device, whether the securities order violates one or more rules; and
in response to determining that the securities order violates one or more rules, performing one or more remedial actions.

12. The method of claim 11, wherein receiving a securities order comprises receiving a securities order from one or more client electronic devices in communication with the client-side optical device.

13. The method of claim 11, wherein performing one or more remedial actions comprises:
invalidating the securities order; and
routing the invalidated securities order to the market-side optical device.

14. The method of claim 11, wherein performing one or more remedial actions comprises causing a communication channel from the client-side optical device and the market-side optical device to be disconnected.

15. The method of claim 11, wherein performing one or more remedial actions comprise not routing one or more subsequently received securities orders to the market-side optical device.

16. The method of claim 11, further comprising sending, by the risk processing device, the securities order to a marketplace exchange electronic device in response to determining that the securities order does not violate one or more of the rules.

17. A method of managing risk associated with securities orders, the method comprising:
receiving, by a market-side optical device associated with a marketplace exchange, order information pertaining to one or more securities orders;
generating, by the market-side optical device, a copy of the order information;
routing the order information to a client-side electronic device;
routing the copy to a risk processing device;
determining, by the risk processing device, whether the order information violates one or more rules; and
in response to determining that the order information violates one or more rules, performing one or more remedial actions.

18. The method of claim 17, wherein performing one or more remedial actions comprises:
invalidating the securities order; and
routing the invalidated securities order to the market-side optical device.

19. The method of claim 17, wherein performing one or more remedial actions comprise causing a communication channel from the client-side optical device and the market-side optical device to be disconnected.

20. The method of claim 17, wherein performing one or more remedial actions comprise not routing one or more subsequently received securities orders to the market-side optical device.
